(19) United States
(12) Patent Application Publication
(10) Pub. No.: US 2014/0159644 A1
(43) Pub. Date: Jun. 12, 2014

(54) Charger Circuit and Charging Control Method

(71) Applicant: Nien-Hui Kung, Hsinchu City (TW)

(72) Inventor: Nien-Hui Kung, Hsinchu City (TW)

(73) Assignee: Richtek Technology Corporation

(21) Appl. No.: 13/712,751

(22) Filed: Dec. 12, 2012

(51) Int. Cl. H02J 7/00

(52) U.S. Cl. CPC H02J 7/0052
USPC 320/107

(57) ABSTRACT

The present invention discloses a charger circuit and a charging control method for charging a battery. When the battery voltage reaches a predetermined voltage, the charge storage quantity of the battery is measured to determine whether to charge the battery according to a constant current mode wherein the battery is charged by a constant current, or the battery voltage is a target to be regulated to a target voltage according to a constant voltage mode.

### BACKGROUND OF THE INVENTION

1. Field of Invention

The present invention relates to a charger circuit and a charging control method, especially a charger circuit and a charging control method which sense battery charge storage quantity.

2. Description of Related Art

Referring to FIG. 1, wherein a prior art charger circuit 1 is shown. The voltage regulator circuit 11 converts an input voltage at the input terminal to an output voltage at the output terminal. The current supply circuit 12 provides current to charge a battery circuit 14 from the output terminal.

The voltage regulator circuit 11 and the current supply circuit 12 is controlled by the control circuit 16; when the voltage sensing circuit 15 detects that the voltage of the battery circuit 14 has not reached the predetermined voltage yet, the control circuit 16 controls the current supply circuit 12 to charge the battery circuit 14 by constant current (that is, the current is the target for regulation and therefore it is referred to as the constant current mode). When the voltage sensing circuit 15 detects that the voltage of the battery circuit 14 reaches the predetermined voltage, the target for regulation target changes to voltage, and the charge current between the current supply circuit 12 and the battery circuit 14 gradually decreases until the voltage of the battery circuit 14 reaches the predetermined voltage target, and this is referred to as the constant voltage mode.

As described above, the charger circuit 1 senses the battery voltage to decide whether to switch from the constant current mode to the constant voltage mode, but this arrangement requires a longer time to complete charging. Referring to FIG. 4A and 4B, the voltage sensing circuit 15 senses the voltage of the battery circuit 14 and finds that it reaches a predetermined voltage V1 at time t1, so the charger circuit 1 switches to the constant voltage mode and the charge current is gradually decreased. However, because the battery has an internal parasitic resistance, the actual internal voltage of the battery circuit 14 has not yet reached the predetermined voltage V1 when the sensed voltage reaches the predetermined voltage V1. Therefore, it is actually too early to switch to the constant voltage mode, and because the charge current decreases in the constant voltage mode, it takes a longer time to complete charging.

For shortening the charging process, a prior art proposes to detect the parasitic resistance in the battery, as shown by the charge control process of FIG. 5. According to this prior art, the battery is initially charged by a first constant current; when the battery voltage reaches the predetermined voltage V1, the parasitic resistance in the battery is detected (i.e., resistance RBAT), and the target voltage of the battery is adjusted to V2 (V2=V1+IA*RBAT), so that the battery can be charged by a second constant current IBAT=IA. When the battery voltage reaches the target voltage V2, the target voltage is switched back to V1. In short, the constant current mode of this prior art has two stages, that is, before the battery voltage reaches the predetermined voltage V1, a first stage constant current mode is chosen wherein the battery is charged by a first constant current; after the battery voltage reaches the voltage V1 but does not reach the voltage V2 yet, a second stage constant current mode is chosen wherein the battery is charged by a second constant current; in the last, the battery target voltage is switched back to V1 and the battery is charged according to the constant voltage mode.

One defect of this prior art is that the second constant current IA may be set improperly because of errors in detecting the internal resistance of the battery, and this may cause damages to the charger circuit or the battery and result in safety problems.

In view of the aforementioned defects of the prior art, the present invention provides a charger circuit and charging control method which can avoid the damages by switching the charge mode according to the battery charge storage quantity. The switching timing is closer to actual requirement, so it reduces the charging time.

### SUMMARY OF THE INVENTION

The above and other objects of the present invention are to provide a charger circuit.

The another object of the present invention is to provide a charging control method.

To achieve one or more of the above and other objects, in one aspect, the present invention discloses a charger circuit, which includes: a voltage regulator circuit for converting an input voltage to an output voltage which is supplied to an output terminal; a current supply circuit coupled between the output terminal and a battery circuit, for charging the battery circuit; a quantity and voltage sensing circuit coupled to the battery circuit, for generating a voltage sensing signal according to a voltage of the battery and a quantity sensing signal according to a charge storage quantity of the battery; and a control circuit for controlling the voltage regulator circuit and the current supply circuit according to the voltage sensing signal and the quantity sensing signal, wherein when the battery voltage reaches a predetermined voltage, the control circuit determines, according to the quantity sensing signal, whether to charge the battery circuit in a constant current mode in which the battery circuit is charged by a first constant current, or a constant voltage mode in which the battery voltage is regulated according to a target voltage.

In a preferable embodiment of the present invention, the quantity and voltage sensing circuit includes a Voltaic Gauge.

The present invention also provides a charging control method, which includes: converting an input voltage to an output voltage which is supplied to a output terminal; charging a battery circuit from the output terminal; sensing the battery voltage; when the battery voltage reaches a predetermined voltage, measuring a charge storage quantity of the battery to generate a quantity sensing signal; and determining, according to quantity sensing signal, whether to charge the battery circuit in a constant current mode in which the battery circuit is charged by a first constant current, or a constant voltage mode in which the battery voltage is regulated according to a target voltage.

In a preferable embodiment of the present invention, the method further includes: charging the battery circuit by a second constant current when the battery voltage is less than the predetermined voltage, wherein the second constant current is equal to or not equal to the first constant current.

In a preferable embodiment of the present invention, when the battery voltage reaches the predetermined voltage,

(1) the battery circuit is charged by the first constant current in the constant current mode when the quantity sensing signal indicates that the charge storage quantity of the battery is less than a first predetermined quantity until the quantity sensing signal indicates that the charge storage quantity of the battery reaches a second predetermined quantity; and
(2) the battery circuit is charged in the constant voltage mode in which the battery voltage is regulated according to the target voltage when the quantity sensing signal indicates that the battery quantity is higher than a second predetermined quantity, wherein the second predetermined quantity is larger than the first predetermined quantity.

In a preferable embodiment of the present invention, the aforementioned step (1) preferably includes: setting a temporary regulation target of the battery voltage, and the temporary regulation target is higher than the predetermined voltage.

In a preferable embodiment of the present invention, the relation among the predetermined voltage V1, the temporary target V2, and the target voltage V3 is: V1≦V3≦V2.

The objectives, technical details, features, and effects of the present invention will be better understood with regard to the detailed description of the embodiments below, with reference to the drawings.

### BRIEF DESCRIPTION OF THE DRAWINGS

FIG. 1 shows a prior art charger circuit 1.

FIGS. 2A-2J show examples of synchronous and asynchronous buck, boost, inverting, and buck-boost voltage regulator circuits.

FIG. 3 shows a preferable embodiment device according to the present invention.

FIGS. 4A-4C show the charge current and battery voltage according to the prior art and the present invention.

FIG. 5 shows a control flow chart according to the prior art.

FIG. 6 shows a control flow chart according to the present invention.

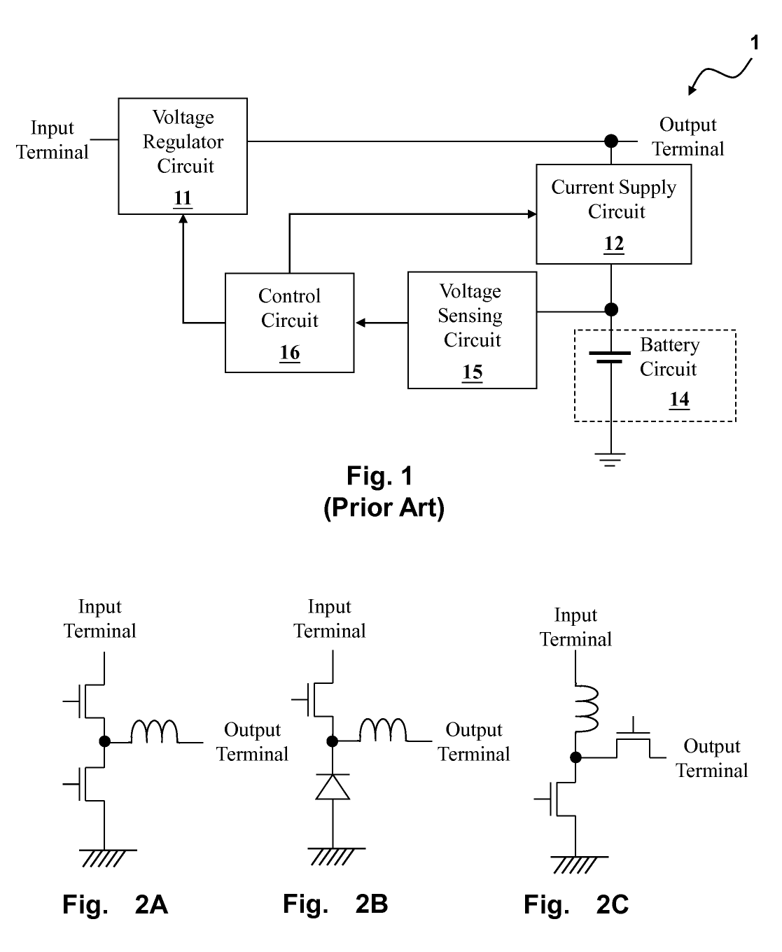

### DESCRIPTION OF THE PREFERRED EMBODIMENTS

FIG. 3 shows an embodiment of a charger circuit 2 according to the present invention. The charger circuit 2 is capable of charging a battery circuit 24, and it includes a voltage regulator circuit 21, a current supply circuit 22, a voltage sensing circuit 15, a quantity gauge circuit 25, and a control circuit 26. The control circuit 26 controls the voltage regulator circuit 21 to convert a voltage at the input terminal to a voltage at the output terminal, and controls the current supply circuit 22 to charge the battery circuit 23. The quantity gauge circuit 25 is coupled to the battery circuit 23, for measuring the charge storage quantity of the battery circuit 24 to generate a quantity sensing signal. The voltage sensing circuit 15 is for sensing the battery voltage; if the quantity gauge circuit 25 can also provide the battery voltage information, then the voltage sensing circuit 15 can be omitted, or it can be construed as that the voltage sensing circuit 15 is included in the quantity gauge circuit 25 in this case. The control circuit 26 generates control signals and decides the operating mode (constant current mode or constant voltage mode) according to the battery voltage information and the quantity sensing signal, preferably according to the followings:

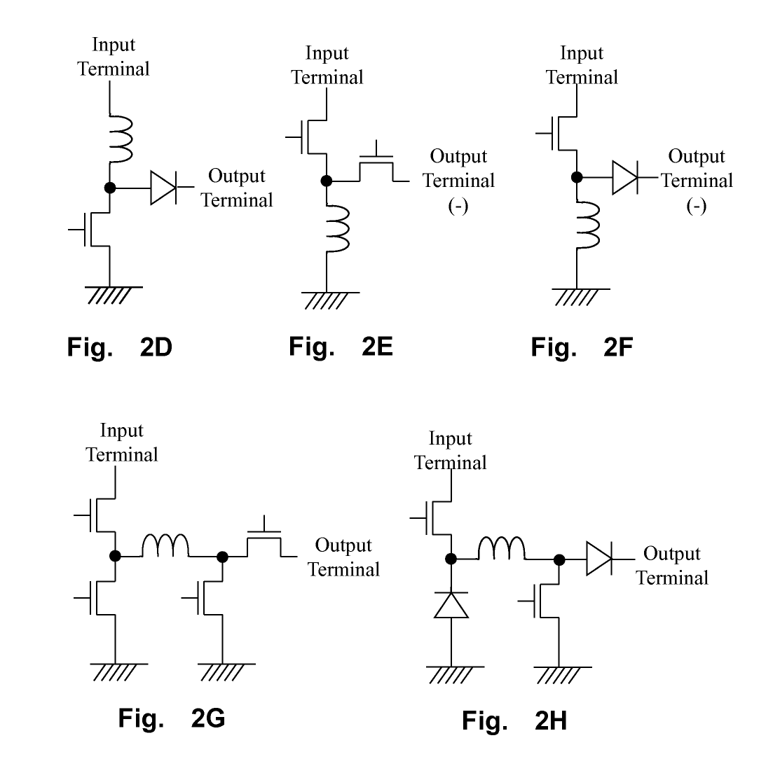

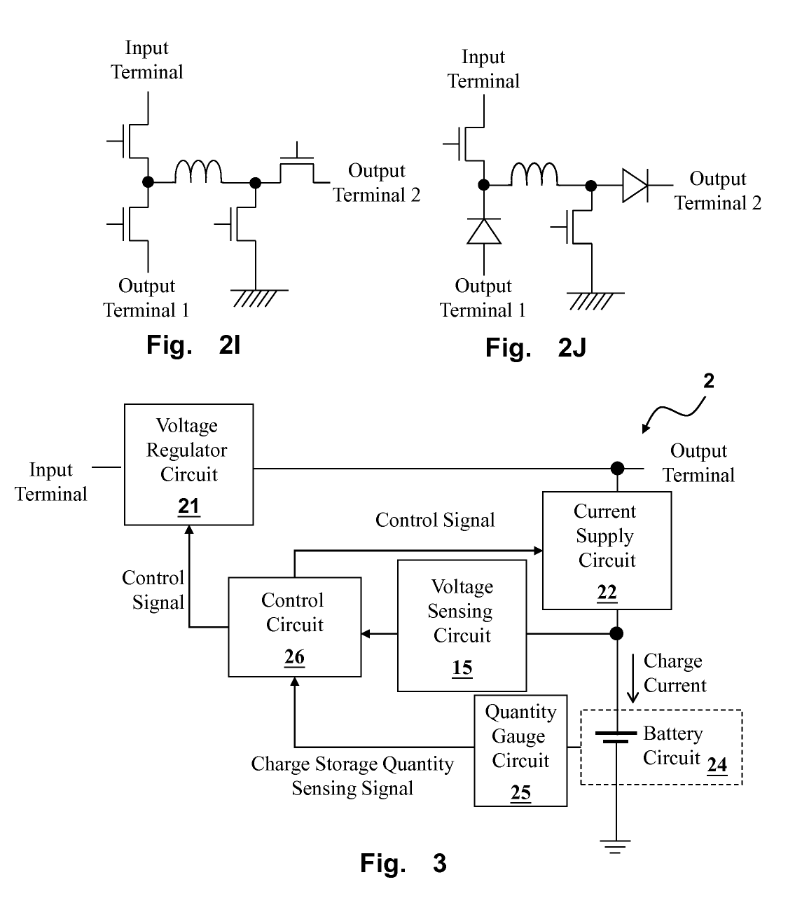

(1) When the quantity sensing signal indicates that the charge storage quantity of the battery circuit 24 is less than a first predetermined quantity, such as X% of the expected fully charged quantity, the control circuit 26 controls the voltage regulator circuit 12 and the current supply circuit 22 to operate in the constant current mode wherein the battery circuit 24 is charged by a constant current, until the quantity sensing signal indicates that the charge storage quantity of the battery circuit 24 reaches a second predetermined quantity, such as Y%, wherein Y>X.
(2) When the quantity sensing signal indicates that the charge storage quantity of the battery circuit 24 is larger than the second predetermined quantity Y%, the control circuit 26 controls the voltage regulator circuit 21 and the current supply circuit 22 to operate in the constant voltage mode, wherein the battery voltage is regulated to a predetermined voltage V1. As examples of X and Y, X can be set between 50˜90 and Y can be set 70˜99; the numbers are only examples and they can be set in any way as long as Y>X. Basically, the charge current is substantially regulated to a constant current in the constant current mode, while the battery voltage is substantially regulated to a constant voltage in the constant voltage mode. The constant voltage can be but not limited to the predetermined voltage V1, and a deviation about the predetermined voltage V1 is acceptable. The voltage regulator circuit 21 for example can be a synchronous or an asynchronous buck, boost, inverting, and buck-boost voltage regulator circuit as shown in FIGS. 2A-2J.

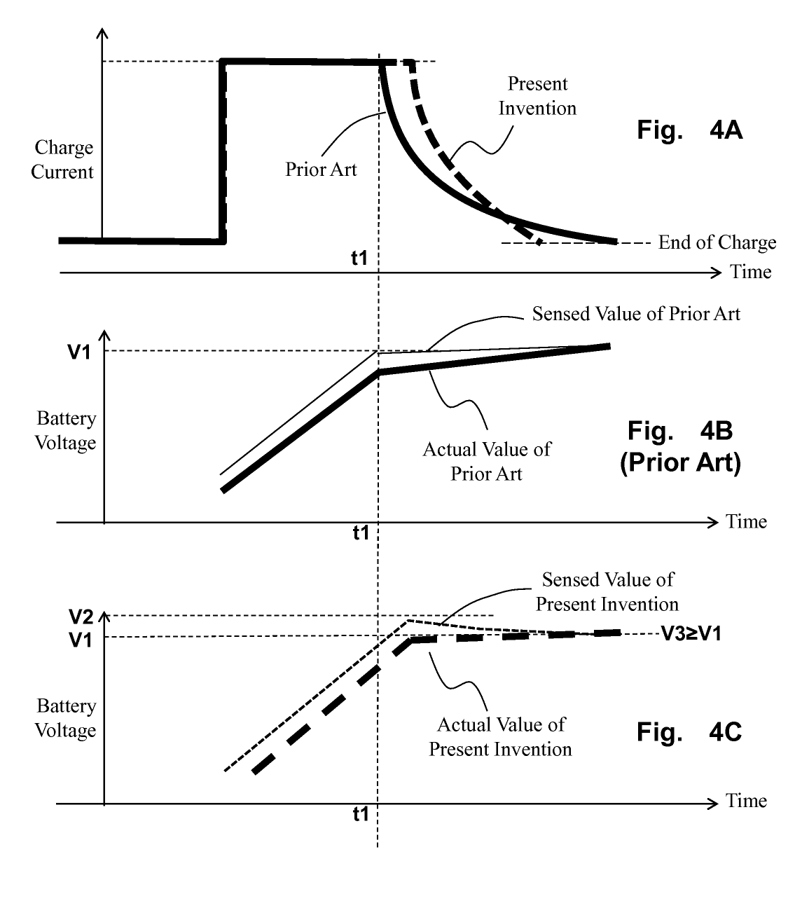

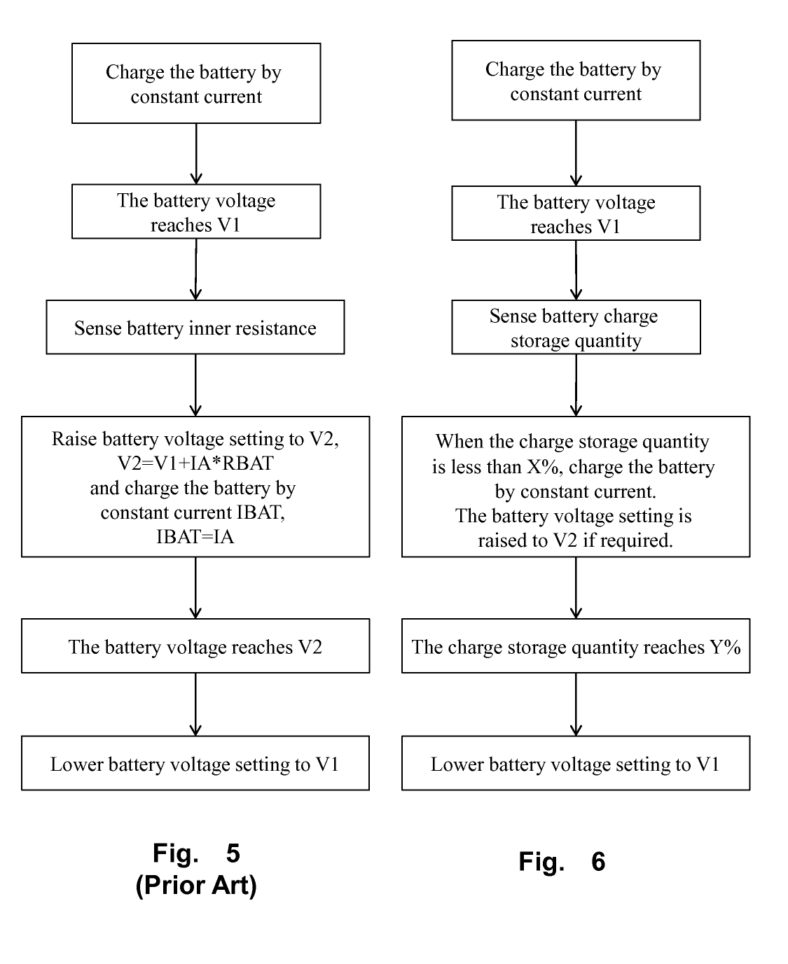

FIGS. 4A-4C show the charge current and the battery voltage generated according to the prior art and the present invention. In the embodiment of the present invention, the battery circuit 24 is charged by a first constant current when the sensed battery voltage does not reach the predetermined voltage V1. When the sensed battery voltage reaches the predetermined voltage V1 (actual battery voltage does not reach voltage V1 yet), the battery quantity is sensed. When the quantity sensing signal indicates that the charge storage quantity of the battery circuit 24 is less than the first predetermined quantity X%, the battery is still charged according to the constant current mode (by a second constant current which can be the same or different from the first constant current), until the quantity sensing signal indicates that the charge storage quantity of the battery circuit 24 reaches the second predetermined quantity Y%. In this stage, the battery voltage might increase to be a little higher than the predetermined voltage V1; this is alright because the target to be controlled is current. However, if it is a concern that the current feedback control and the voltage feedback control might conflict with each other, the regulation target of the battery voltage can be temporarily set to any predetermined voltage V2 which is higher than the voltage V1. The purpose to set a higher regulation target V2 is not to regulate the battery voltage to the target V2, but just for the circuit to remain operating in the constant current mode. When the quantity sensing signal indicates that the charge storage quantity of the battery circuit 24 is higher than the second predetermined quantity Y%, the charger circuit 2 switches to the constant voltage mode, and the target of the battery voltage can be set to a predetermined voltage V3 (V1≦V3≦V2), whereby the battery voltage is regulated to this target voltage. The predetermined voltage V3 for example can be equal to the predetermined voltage V1, such as the embodiment shown in FIG. 4; however, the present invention is not limited to this embodiment and the predetermined voltage V3 can be set to any other voltage not lower than the predetermined voltage V1.

Comparing the charge currents according to the prior art and the present invention shown in FIG. 4A, the charge current of the present invention descends at a later timing, while the charge process finishes earlier (it is assumed that the charging current being lower than a threshold indicates completion of charging); in other words, the present invention can complete charging faster. Moreover, if the first and second constant currents are the same, the present invention only needs one constant current source in the circuit, so the cost is lower than the prior art which has two constant current stages with different currents. Besides, it is not necessary to calculate the internal resistance in the present invention, so the present invention reduces the risk of circuit damages or safety issue caused by incorrect calculation of the internal resistance. The benefits of the present invention are obvious over the prior art.

The present invention measures the charge storage quantity of the battery by a quantity gauge circuit, which for example can be but not limited to a Voltaic Gauge that is capable of generating a quantity index according to mapping between the battery voltage and the charge current. Voltaic Gauge is a well known device, and its detailed explanation is omitted here.

Referring to FIG. 6, a charge control flow chart according to a preferable embodiment of the present invention is shown. As shown in figure, first, the battery is charged by a constant current, and when the battery voltage reaches the predetermined voltage V1, sense the battery charge storage quantity. When the sensed quantity is less than X%, keep charging by the constant current mode (wherein the current is preferably the same as but can be different from the previous current), and the target voltage setting of the battery can be raised from the predetermined voltage V1 to the predetermined voltage V2 if necessary. Next, when the battery quantity reaches Y%, the battery target voltage is set to V3. Referring the FIGS. 4A and 6, in this embodiment, preferably, the constant current mode has only one stage which charges the battery by one constant current, that is, the battery is charged by the constant current before the battery voltage reaches the predetermined voltage V1 and until the battery charge storage quantity reaches Y%, and in the last, the battery target voltage is set to V3 (V3≧V1), and the battery voltage is regulated to V3 by the constant voltage mode after the battery charge storage quantity reaches Y%. However, the only one constant current stage and one constant current is preferred but not necessary. Referring to FIG. 4A, in another embodiment, the charge currents before and after the sensed battery voltage reaches the predetermined voltage V1 (before and after time t1) can be different.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a circuit or device which does not affect the primary function of the circuit can be inserted between two circuits or devices shown to be in direct connection in the figures, such as a switch. An embodiment or a claim of the present invention does not need to attain or include all the objectives, advantages or features described in the above. The abstract and the title are provided for assisting searches and not to be read as limitations to the scope of the present invention. In view of the foregoing, the spirit of the present invention should cover all such and other modifications and variations, which should be interpreted to fall within the scope of the following claims and their equivalents.

What is claimed is:

1. A charger circuit, comprising:
a voltage regulator circuit for converting an input voltage to an output voltage which is supplied to an output terminal;
a current supply circuit coupled between the output terminal and a battery circuit, for charging the battery circuit;
a quantity and voltage sensing circuit coupled to the battery circuit, for generating a voltage sensing signal according to a voltage of the battery and a quantity sensing signal according to a charge storage quantity of the battery; and
a control circuit for controlling the voltage regulator circuit and the current supply circuit according to the voltage sensing signal and the quantity sensing signal, wherein when the battery voltage reaches a predetermined voltage, the control circuit determines, according to the quantity sensing signal, whether to charge the battery circuit in a constant current mode in which the battery circuit is charged by a first constant current, or a constant voltage mode in which the battery voltage is regulated according to a target voltage.

2. The charger circuit of claim 1, wherein when the battery voltage is less than the predetermined voltage, the battery circuit is charged by a second constant current, wherein the second constant current is equal to or not equal to the first constant current.

3. The charger circuit of claim 1, wherein when the battery voltage reaches the predetermined voltage,
(1) the battery circuit is charged by the first constant current in the constant current mode when the quantity sensing signal indicates that the charge storage quantity of the battery is less than a first predetermined quantity until the quantity sensing signal indicates that the charge storage quantity of the battery reaches a second predetermined quantity; and
(2) the battery circuit is charged in the constant voltage mode in which the battery voltage is regulated according to the target voltage when the quantity sensing signal indicates that the battery quantity is higher than a second predetermined quantity,
wherein the second predetermined quantity is larger than the first predetermined quantity.

4. The charger circuit of claim 3, wherein the target voltage is higher than or equal to the predetermined voltage.

5. The charger circuit of claim 1, wherein the quantity and voltage sensing circuit includes a Voltaic Gauge.

6. A charging control method, comprising:
converting an input voltage to an output voltage which is supplied to a output terminal;
charging a battery circuit from the output terminal;
sensing the battery voltage;
when the battery voltage reaches a predetermined voltage, measuring a charge storage quantity of the battery to generate a quantity sensing signal; and
determining, according to quantity sensing signal, whether to charge the battery circuit in a constant current mode in which the battery circuit is charged by a first constant current, or a constant voltage mode in which the battery voltage is regulated according to a target voltage.

7. The charging control method of claim 6, further including: charging the battery circuit by a second constant current when the battery voltage is less than the predetermined voltage, wherein the second constant current is equal to or not equal to the first constant current.

8. The charging control method of claim 6, wherein when the battery voltage reaches the predetermined voltage,
(1) the battery circuit is charged by the first constant current in the constant current mode when the quantity sensing signal indicates that the charge storage quantity of the battery is less than a first predetermined quantity until the quantity sensing signal indicates that the charge storage quantity of the battery reaches a second predetermined quantity; and
(2) the battery circuit is charged in the constant voltage mode in which the battery voltage is regulated according to the target voltage when the quantity sensing signal indicates that the battery quantity is higher than a second predetermined quantity,
wherein the second predetermined quantity is larger than the first predetermined quantity.

9. The charging control method of claim 8, wherein the target voltage is higher than the predetermined voltage.

10. The charging control method of claim 8, wherein the step (1) includes setting a temporary regulation target of the battery voltage, and the temporary regulation target is higher than the predetermined voltage.

11. The charging control method of claim 10, wherein the relation among the predetermined voltage V1, the temporary regulation target V2, and the target voltage V3 is:
V1≦V3≦V2.
